(19) United States
(12) Patent Application Publication
(10) Pub. No.: US 2009/0023330 A1
(43) Pub. Date: Jan. 22, 2009

(54) Systems For Electrically Connecting Processing Devices Such As Central Processing Units And Chipsets

(75) Inventors: Stuart C. Stoner, Lewisbury, PA (US); L. Robin Johnson, Dover, PA (US); Mark R. Gray, York, PA (US); Douglas M. Johnescu, York, PA (US)

Correspondence Address: WOODCOCK WASHBURN, LLP, CIRA CENTRE, 12TH FLOOR, 2929 ARCH STREET, PHILADELPHIA, PA, 19104-2891, US

(73) Assignee: FCI AMERICA'S TECHNOLOGY INC., Carson City, NV (US)

(21) Appl. No.: 12/141,752

(22) Filed: Jun. 18, 2008

Related U.S. Application Data
(60) Provisional application No. 60/950,328, filed on Jul. 17, 2007.

(51) Int. Cl. H01R 12/24

(52) U.S. Cl. 439/493

(57) ABSTRACT

A cable assembly for electrically connecting processing devices may be provided. The cable assembly may include a cable such as a flat flexible cable. The cable may include a plurality of electrical leads at a first and second end. The electrical leads at the first end may be mounted to a respective contact in a first electrical connector. Similarly, the electrical leads at the second end may be mounted to a respective contact in a second electrical connector. The cable assembly may further include respective first and second clamps that may positioned at each end of the cable. The first and second clamps may be used to secure the first and second electrical connectors to a substrate of processing device.

### CROSS-REFERENCE TO RELATED APPLICATIONS

This application claims benefit under 35 U.S.C. §119(e) of U.S. Provisional Patent Application No. 60/950,328, filed on Jul. 17, 2007, the disclosure of which is incorporated herein by reference.

### BACKGROUND

Electrical connectors may be used to provide an electrical connection between various processing devices such as two central processing units, a central processing unit and a chip set, or the like. Typically, the processing devices may be mounted to a substrate such as a printed circuit board, a socket, or the like. The substrate may include an electrical connector that may be electrically coupled to the processing device through traces etched in the substrate. A cable may then be connected to the electrical connectors on the substrates such that the two processing devices may be electrically coupled. Unfortunately, using such a technique, the cable may be difficult to connect to the electrical connector after the electrical connector is electrically coupled to a substrate.

### SUMMARY

A cable assembly for electrically connecting processing devices may be provided. The cable assembly may include a cable such as a flat flexible cable. The cable may include a plurality of electrical leads at a first and second end. The electrical leads at the first end may be mounted to a respective contact in a first electrical connector. Similarly, the electrical leads at the second end may be mounted to a respective contact in a second electrical connector. The first and second electrical connectors having the cable attached therebetween may then be mounted to a respective processing device.

The cable assembly may further include a first and second clamp that may be used to secure the first and second connectors to the respective processing devices. The first and second clamps may include a top portion, a bottom portion, and a back portion that may be disposed between the top portion and the bottom portion at corresponding ends of the top portion and the bottom portion.

The back portion of the first and second clamps may have a first and second slot defined therein. The first and second slots may receive a respective first and second half portion of the cable. For example, the cable may include a slit that may define a respective first and second half portion at each of the first and second ends. The first slot of the first and second clamps may receive the first half portion. The second slot of the first and second clamps may receive the second half portion. Upon receipt of the cable through the first slot and the second slot of the first and second clamps, the first and second electrical connectors may then be mounted to the cable at the respective first and second ends.

The top portion of the first and second clamps may include a protrusion extending from a bottom side. The protrusion may be received in a channel defined in a plate portion of the cable assembly. The plate portion may include a top and bottom side. The bottom side may contact the first and second ends of the cable where the respective contacts in the first and second electrical connectors may be mounted to a respective lead. The top side of the plate portion may include a channel defined therein that may receive the protrusion of the first and second clamps.

The bottom portion of the first and second clamps may include a first and second aperture defined therethrough. The first and second apertures may receive a respective first and second alignment pin of the first and second electrical connectors. For example, the first and second electrical connectors may be positioned on a substrate of the processing devices by placing a respective first and second alignment pin in a corresponding opening on the substrate. The first and second compression clamps may then be slid toward and urged onto the first and second electrical connector such that the channel may receive the protrusion and the first and second apertures may receive the first and second alignment pins.

### BRIEF DESCRIPTION OF THE DRAWINGS

FIGS. 1-2 depict side and isometric views, respectively, of an example embodiment of a first processing device electrically coupled to a second processing device.

FIG. 3 depicts a partial, bottom isometric view of an end of a cable assembly that may be used to couple a first processing device to a second processing device.

FIG. 4 depicts a partial, top isometric view of an end of a cable assembly that may be used to couple a first processing device to a second processing device.

FIG. 5 depicts a back view of an of an example embodiment of a compression clamp of a cable assembly.

FIGS. 6-8 depict cutaway isometric views of a cable assembly being connected to a processing device.

FIGS. 9-10 depict cutaway isometric and side views, respectively, of a cable assembly connected to a processing device.

FIG. 11 depicts an isometric view of an example embodiment of a cable system that may be used to electrically connect a first processing device to a second processing device.

FIGS. 12-13 depict partial, isometric views of another example embodiment of a cable system that may be used to electrically connect a first processing device to a second processing device.

FIGS. 14-16 depict partial, isometric views of a connector system that may be used to electrically connect a first processing device to a second processing device.

### DETAILED DESCRIPTION OF ILLUSTRATIVE EMBODIMENTS

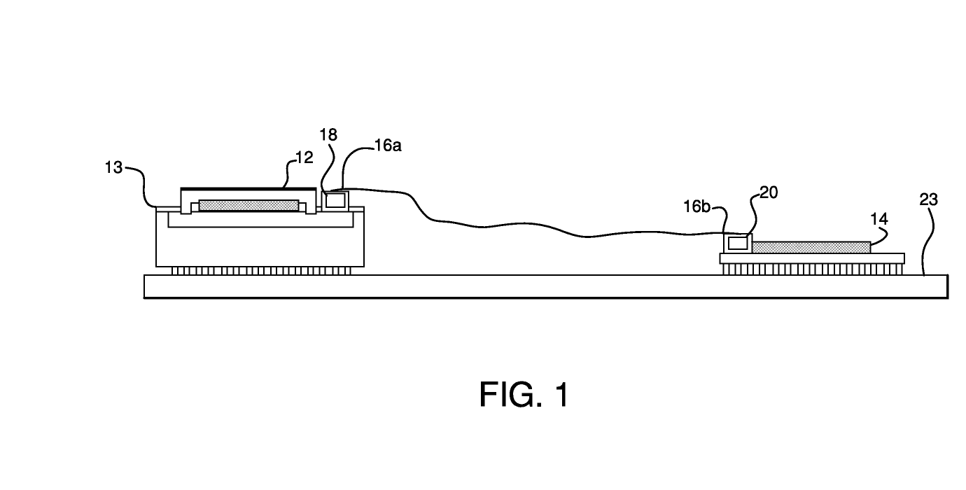

FIGS. 1-2 depict side and isometric views, respectively, of an example embodiment of a first processing device such as a central processing unit (CPU) 12 electrically coupled to a second processing device such as a chipset 14. As shown in FIG. 1, the CPU 12 and the chipset 14 may be mounted to a substrate 23 such as a motherboard. For example, the CPU 12 may be received in a socket 13 that may be mounted to the substrate 23. Similarly, the chipset 14 may include one or more integrated circuits that may be mounted to the substrate 23. The CPU 12 may be electrically connected to the chipset 14 via a cable assembly 10.

The cable assembly 10 may include a cable 16, a first electrical connector 18, and a second electrical connector 20. The cable 16 may be a high speed flexible connector cable such as a flat flexible cable (FFC) that may include a plurality of conductive traces therein. The first electrical connector 18 and the second electrical connector 20 may be high speed electrical connector such as a land grid array (LGA) connector that may include one or more electrical contacts therein. A first end 16a of the cable 16 may be mounted to the first electrical connector 18 and a second end 16b of the cable 16 may be mounted to the second electrical connector 20, which will be described in more detail below.

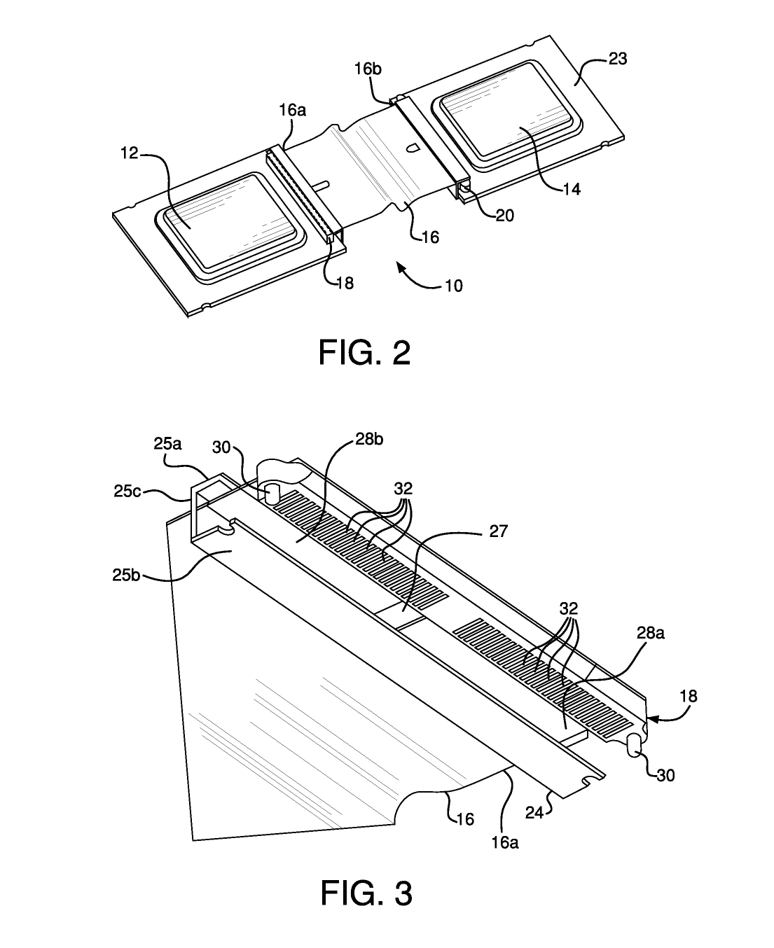

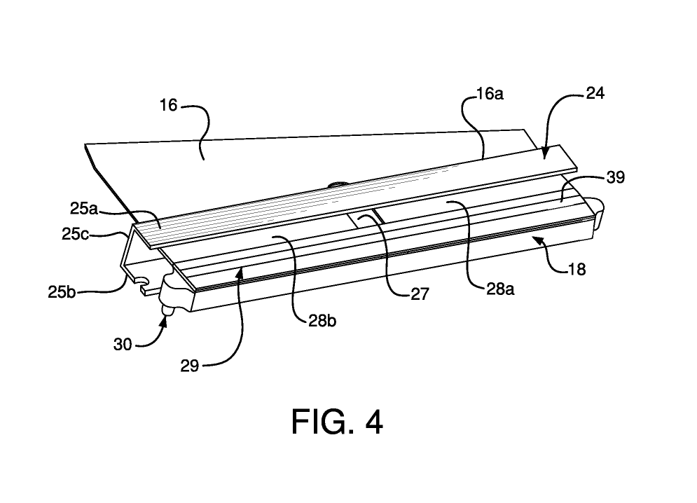

FIGS. 3-4 depict, respectively, a partial top isometric view and a partial bottom isometric view of an end of a cable assembly 10 that may be used to couple a first processing device such as the CPU 12 to a second processing device such as the chipset 14. The cable assembly 10 may include compression clamps 24. The compression clamps 24 may be made of, for example, a polymer such as plastic, thermoplastic, or the like, a metal such as a copper alloy, stainless steel, or the like, and/or any other suitable material. The compression clamps 24 may include a top portion 25a, a bottom portion 25b, and a back portion 25c extending between the top and bottom portions 25a, 25b at corresponding ends thereof.

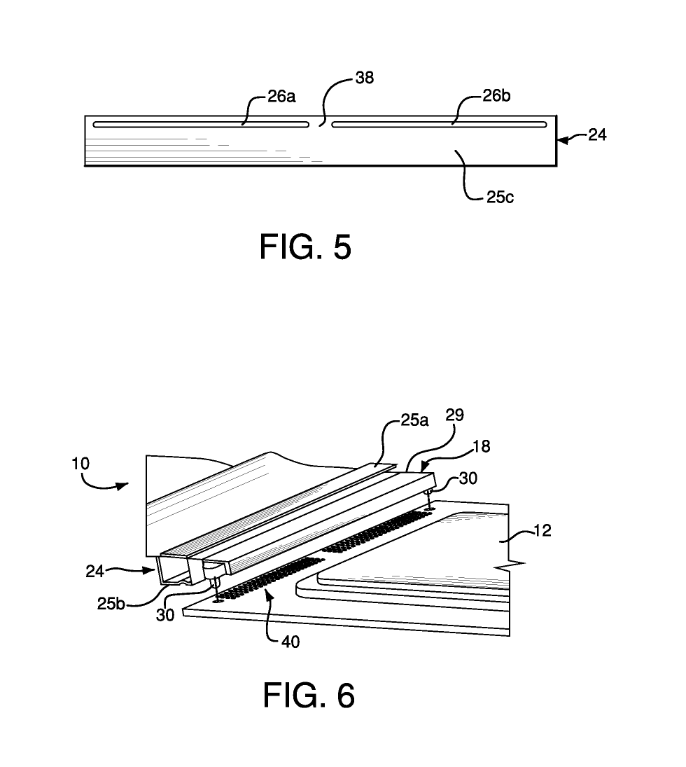

FIG. 5 depicts a back view of an example embodiment of the compression clamps 24 of a cable assembly 10. The back portion 25c of the compression clamps 24 may have an opening formed therein. The opening may include first and second slots 26a, 26b that my be separated by a member 38 of the back portion 25c therebetween. The member 38 separating the first and second slots 26a, 26b may add rigidity to the compression clamps 24 such that the compression clamps 24 may be stiffer and more resolute to bowling at the center of the compression clamps 24.

The first and second slots 26a, 26b may receive a portion of the ends of the cable 16. For example, as shown in FIGS. 3-4, the cable 16 may include first and second ends 16a, 16b (second end 16b not shown). Each of the first and second ends 16a, 16b may have a slit 27 formed therein that divides each of the first and second ends 16a, 16b into respective first and second halves 28a, 28b. The compression clamps 24 may be slid over the respective first and second ends 16a, 16b such that first and second halves 28a, 28b of the first and second ends 16a, 16b may be disposed within a respective one of the first and second slots 26a, 26b, shown in FIG. 5.

The cable assembly 10 may further include the first electrical connector 18 and the second electrical connector 20 (see FIG. 2). As shown in FIGS. 3-4, the first electrical connector 18 may be electrically and mechanically connected to the first end 16a of the cable 16 after the respective compression clamp 24 has been placed on the first end 16a. For example, after the respective compression clamp 24 has been placed on the first end 16a, the first electrical connector 18 may be soldered to an inwardly facing surface of the first end 16a of the cable 16 such that the conductive traces or leads in the cable 16 may be in electrical connection with contacts 32 in the first electrical connector 18.

Similarly, the second electrical connector 20, shown in FIGS. 1-2, may be electrically and mechanically connected to the second end 16b of the cable 16 after the respective compression clamp 24 has been placed on the second end 16b. For example, after the respective compression clamp 24 has been placed on the second end 16b, the second electrical connector 20 may be soldered to an inwardly facing surface of the second end 16b of the cable 16 such that the conductive traces or leads in the cable 16 may be in electrical connection with the contacts (not shown) in the second electrical connector 20.

After the first and second electrical connectors 18, 20 have been electrically connected to the respective first and second ends 16a, 16b of the cable 16, a respective backer plate 29 (see FIG. 4) may be attached to the outwardly-facing surfaces of the first and second ends 16a, 16b of the cable 16 above the respective first and second electrical connectors 18, 20 to, for example, mechanically connect the first and second electrical connectors 18, 20 to the cable 16. Each backer plate 29 may have a channel 39 formed along the length thereof such that the channel 39 that may receive a portion of the respective compression clamp 24, which will be described in more detail below.

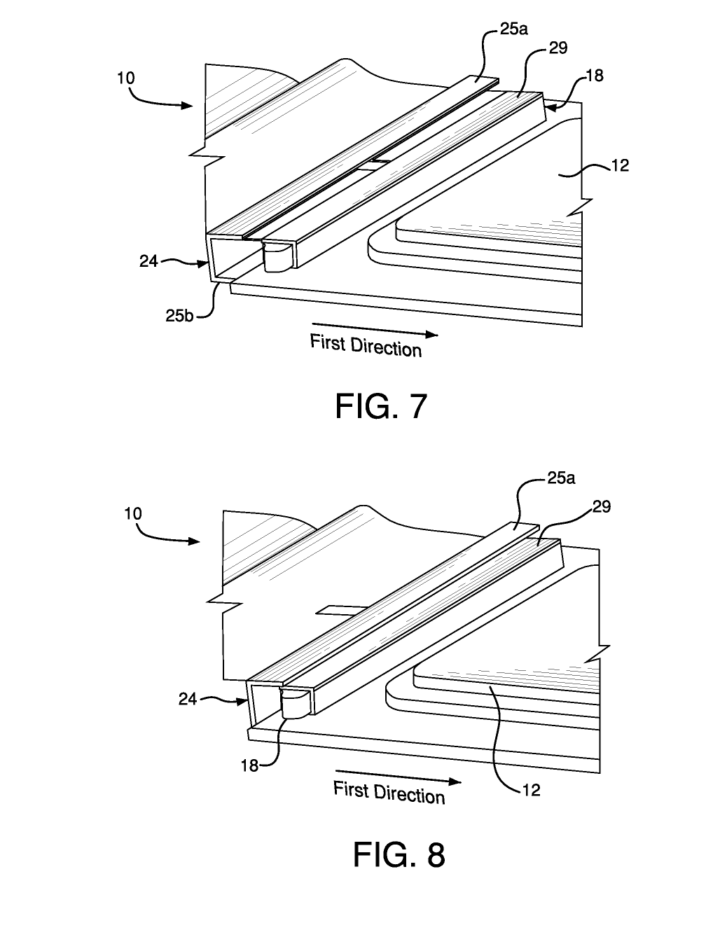

As described above, the first and second electrical connectors 18, 20 may include a plurality of contacts 32. The contacts 32 may be arranged such that each of the contacts 32 in the arrangement may correspond to a respective electrically-conductive pad or trace on the substrate of the CPU 12. For example, as shown in FIG. 3, the contacts 32 of each of the first and second electrical connectors 18, 20 may be arranged in two grids with each of the two grids including four rows and twenty-eight columns of the contacts 32. The electrically-conductive pads 40, shown in FIG. 6, on the substrate of the CPU 12 and chipset 14 may also be arranged in two grids with each of the two grids including four rows and twenty-eight columns of the electrically-conductive pads 40 such that each of the contacts 32 may correspond to a respective electrically-conductive pad 40.

The first and second electrical connectors 18, 20 may further include alignment pins 30. The alignment pins 30 may extend at opposite ends of a bottom portion of the respective first and second electrical connectors 18, 20. The alignment pins 30 may be used to align the contacts 32 with the electrically-conductive pads on a substrate of a processing device such as the CPU 12 electrically mounted thereto.

FIGS. 6-10 depict cutaway views of the cable assembly 10 being connected and connected to a processing device such as the CPU 12. For example, the first electrical connector 18 may be mounted on a substrate of the CPU 12 by aligning the alignment pins 30 with corresponding apertures or openings such as holes or slots in the substrate. The first electrical connector 18 may then be moved toward the substrate such that each of the contacts 32 (see FIG. 3) of the first electrical connector 18 may contact and seat on respective electrically-conductive pads 40 on the substrate of the CPU 12.

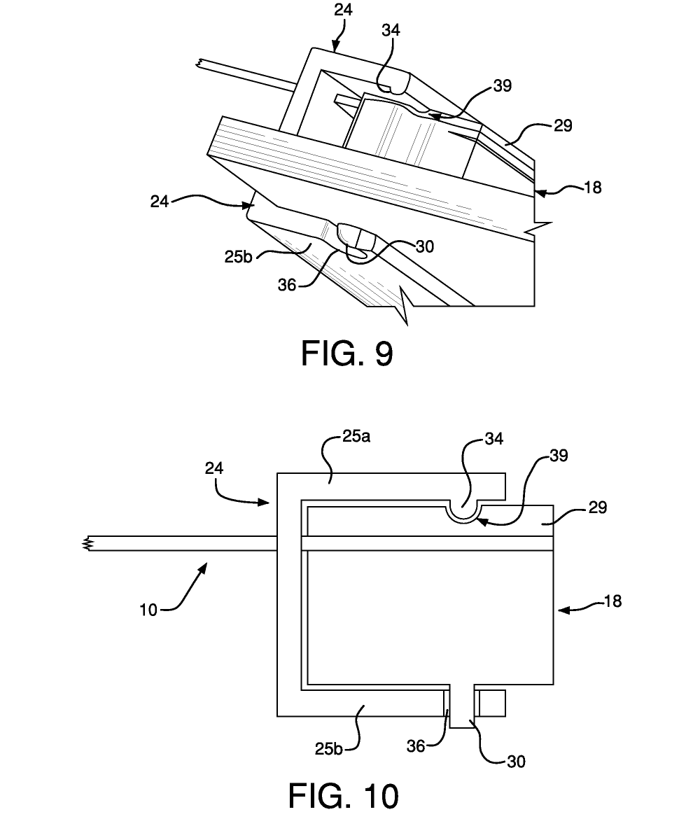

The compression clamp 24 associated with the first electrical connector 18 may then be slid toward and urged onto the first electrical connector 18 in a first direction. As best seen in FIGS. 9-10, the top portion 25a of the compression clamp 24 may include a rounded projection or protrusion 34 extending from a bottom side thereof. The protrusion 34 may be positioned on the bottom side relative to the channel 39 such that the protrusion 34 may be disposed or received into the channel 39 of the backer plate 29 as the compression clamp 24 may be urged over the first electrical connector 18.

As best seen in FIGS. 9-10, the bottom portion 25b of the compression clamp 24 may include apertures 36 formed therethrough at opposite ends. The apertures 36 may be positioned relative to the alignment pins 30 such that the apertures 36 may receive the alignment pins 30. For example, when the compression clamp 24 may be urged over the first electrical connector 18, the apertures 36 may receive lower ends of the alignment pins 30. Upon receipt of the alignment pins 30, the apertures 36 may enable the compression clamp 24 to be retained on the first electrical connector 18. For example, the contact between the alignment pins 30 and the peripheral surfaces of the apertures 36 may help to secure the compression clamp 24 on the first electrical connector 18.

The protrusion 34 and the channel 39 may form a pivot joint that may locate the compression clamp 24 such that the compression clamp 24 may be pivoted in relation to the CPU 12. For example, upon urging the compression clamp 24 onto the first electrical connector 18, the protrusion 34 that may be disposed in the channel 39 may be pivoted toward the CPU 12 such that the compression clamp 24 may compress the contacts 32 of the first electrical connector 18 onto the electrically-conductive pads on the substrate of the CPU 12.

Additionally, the compression clamp 24 may be angled in relation to the first electrical connector 18 such that the protrusion 34 may be disposed in the channel 39 of the backer plate 29 before the bottom portion 25b of the compression clamp 24 may contact the alignment pins 30. The compression clamp 24 may then be pivoted to bring the bottom portion 25b of the compression clamp 24 into contact with the alignment pins 30 such that the apertures 36 may receive the alignment pins 30.

The second electrical connector 20 may also be mated with the chipset 14 using a compression clamp 24 as described above.

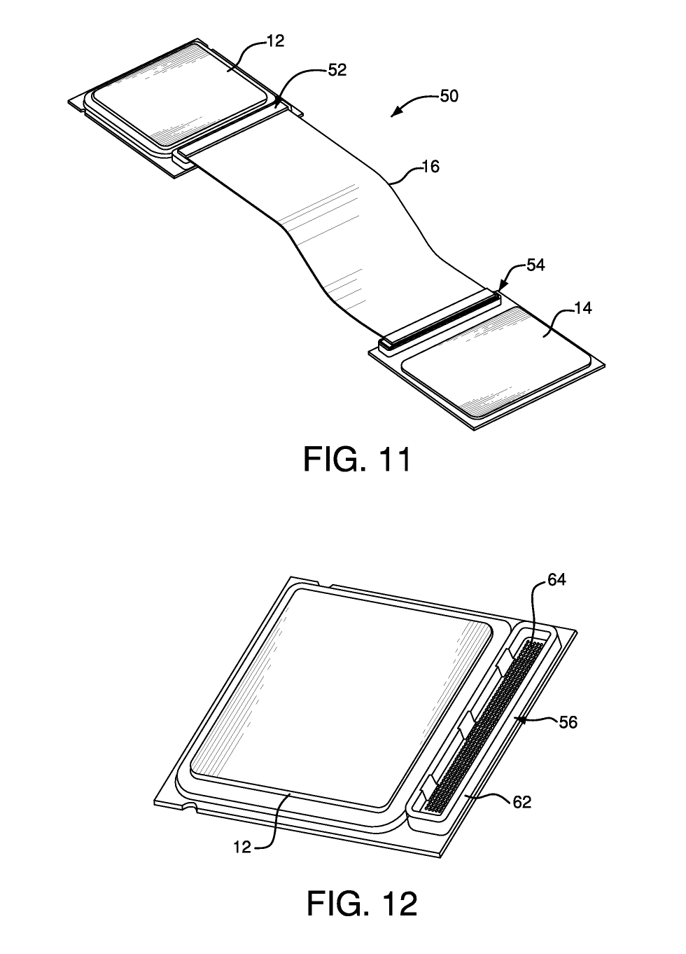

FIG. 11 depicts an isometric view of an example embodiment of a cable system 50 that may be used to electrically connect a first processing device such as a CPU 12 to a second processing device such as a chipset 14. The cable system 50 may include the cable 16, a first electrical connector 52, and a second electrical connector 54. The first and second electrical connectors 52, 54 may be high speed electrical connectors such as mezzanine-type electrical connectors that may include a plurality of contacts therein.

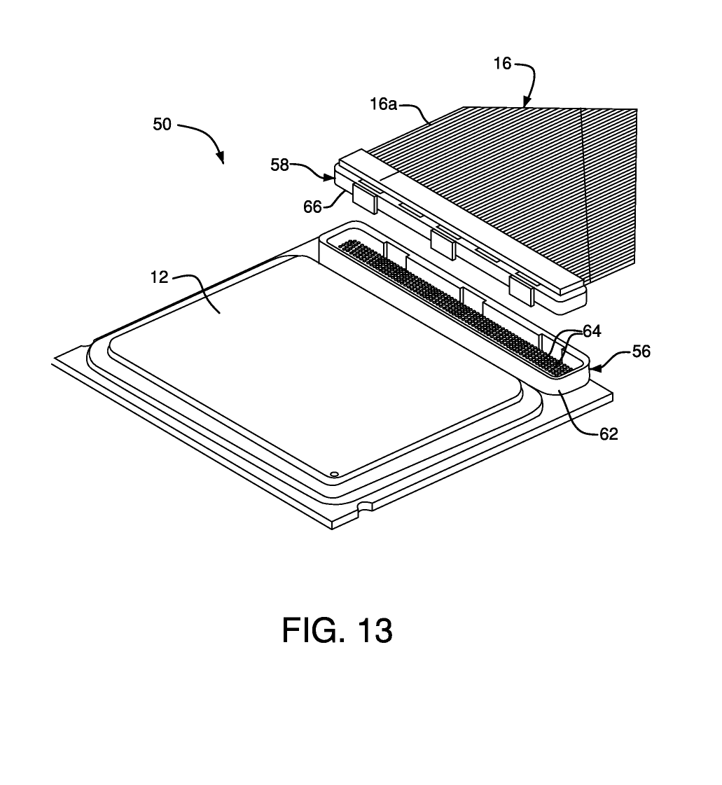

FIGS. 12-13 depict partial, isometric views of another example embodiment of a cable system that may be used to electrically connect a first processing device to a second processing device. The first electrical connector 52 (see FIG. 11) may include a first substrate connector 56 and a first cable connector 58 that may mate with the first substrate connector 56. The first substrate connector 56 may be a receptacle portion that may include a housing 62. The housing 62 may be made of a dielectric material such as plastic, thermoplastic, or the like and may include a plurality of electrically-conductive contacts 64 mounted therein. Similarly, The first cable connector 58 may be a plug portion that may include a housing 66. The housing 66 may be made of a dielectric material such as plastic, thermoplastic, or the like and may include a plurality of electrically-conductive contacts (not shown) mounted therein. Each contact 64 of the first substrate connector 56 may be mated with a respective contact (not shown) of the first cable connector 58 when the first cable connector 58 may be received in the first substrate connector 56.

The first substrate connector 56 may be electrically and mechanically connected to a substrate that may includes the CPU 12 by any suitable means such as, for example, solder connections between the contacts 64 and electrically-conductive pads on the substrate of the CPU 12.

The solder connections may be formed using a ball grid array of the first substrate connector 56. For example, a solder ball may be attached to each of the contacts 64 of the first substrate connector 56. The solder balls may then be melted in a reflow process. The molten solder, upon cooling, may form solder connections between the contacts 64 and corresponding contact pads on the CPU 12.

Similarly, the first cable connector 58 may be electrically and mechanically connected to the first end 16a of the cable 16 by any suitable means such as solder connections between the contacts of the first cable connector 58 and corresponding conductive traces or leads of the cable 16.

The solder connections may be formed using a ball grid array of the first cable connector 58. For example, a solder ball may be attached to each of the contacts of the first cable connector 58. The solder balls may then be melted in a reflow process. The molten solder, upon cooling, may form solder connections between the contacts of the first cable connector 58 and the corresponding conductive traces or leads at the first end 16a of the cable 16.

The second electrical connector 54 (see FIG. 11) may include a second substrate connector like the first substrate connector 56 and a second cable connector such as the first cable connector 58 described above with respect to the first electrical connector 52 (see FIG. 11).

The first cable connector 58 and the first substrate connector 56 of the first and second electrical connectors 52, 54 (see FIG. 11) may be mated and de-mated with relative ease to provide separable connections between the CPU 12 and the chipset 14 (see FIG. 11). Additionally, in another example embodiment, the first cable connector 58 may be mounted on a substrate of the CPU 12 and chipset 14, and the receptacle portions 56 may be mounted on the cable 16.

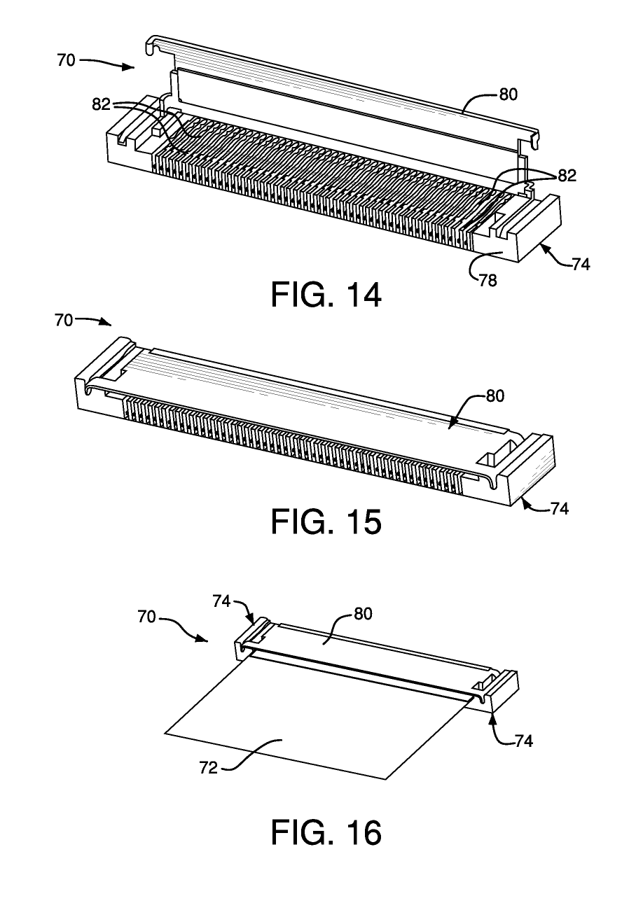

FIGS. 14-16 depict another example embodiment of a connector system that may be used to electrically connect a first processing device to a second processing device. For example, a connector system 70 such as a flexible printed circuit connector system may be used to electrically connect a CPU and a chipset. The connector system 70 may include a flexible printed circuit (FPC) 72 and connectors 74 at each end of the FPC 72. One of the connectors 74 may be mounted on a substrate of the CPU. The other connector 74 may mounted on a substrate of the chipset. The connectors 74 may each include a housing 78 and a cover plate 80 that may be pivotally coupled to the housing 78.

An end of the FPC 72 may be placed on the housing 78 while the cover plate 80 is in an open position. Upon receiving the FPC 72, the cover plate 80 may be rotated into a closed position and locked using, for example, a latch. The cover plate 80 may provide an electrical connection between electrically-conductive traces or leads on the end of the FPC 72 and respective contacts 82 located within the housing 78. For example, when the cover plate 80 may be closed and locked, each of the respective electrically-conductive traces or leads may contact a respective contact 82 such that the contacts 82 may form a conductive path between the FPC 72 and the CPU or chipset.

What is claimed:

1. A cable assembly comprising:
a cable comprising a first electrical lead at a first end;
a first electrical connector comprising a first electrical contact mounted to the first electrical lead of the cable at the first end; and
a first clamp defining a first opening therein, wherein the first end of the cable is received through the first opening of the first clamp, and wherein the first clamp is adapted to secure the first electrical connector to a first substrate.

2. The cable assembly of claim 1, wherein the first clamp defines a top portion, a bottom portion, and a back portion disposed between the top and bottom portions.

3. The cable assembly of claim 1, further comprising a plate portion connected to the first electrical connector, the plate portion defining a channel therein.

4. The cable assembly of claim 3, wherein the first clamp defines a protrusion extending therefrom, and wherein the channel is adapted to receive the protrusion.

5. The cable assembly of claim 1, wherein the first electrical connector comprises an alignment pin.

6. The cable assembly of claim 5, wherein the first clamp defines an aperture therethrough, wherein the aperture is adapted to receive the alignment pin.

7. The cable assembly of claim 1, wherein the cable comprises a second electrical lead at a second end.

8. The cable assembly of claim 7, further comprising a second electrical connector comprising a second electrical contact mounted to the second electrical lead of the cable at the second end.

9. The cable assembly of claim 8, further comprising a second clamp defining a second opening therein, wherein the second end of the cable is received through the second opening of the second clamp, and wherein the second clamp is adapted to secure the second electrical connector to a second substrate.

10. A cable assembly system comprising:
a cable comprising a first electrical lead at a first end and a second electrical lead at a second end;
a first electrical connector and a second electrical connector, the first electrical connector comprising a first electrical contact mounted to the first electrical lead of the cable at the first end and the second electrical connector comprising a second electrical contact mounted to the second electrical lead of the cable at the second end; and
a first clamp and a second clamp, the first clamp defining a first opening therein and the second clamp defining a second opening therein, wherein the first end of the cable is received through the first opening of the first clamp and the second end of the cable is received through the second opening of the second clamp, and wherein the first clamp is adapted to secure the first electrical connector to a first substrate and the second clamp is adapted to secure the second electrical connector to a second substrate.

11. The cable assembly system of claim 10, further comprising a first plate portion connected to the first electrical connector, the first plate portion defining a first channel therein.

12. The cable assembly system of claim 11, wherein the first clamp defines a first protrusion, and wherein the first channel is adapted to receive the first protrusion.

13. The cable assembly system of claim 12, further comprising a second plate portion connected to the second electrical connector, the second plate portion defining a second channel therein.

14. The cable assembly system of claim 13, wherein the second clamp defines a second protrusion, and wherein the second channel is adapted to receive the second protrusion.

15. The cable assembly of system claim 10, wherein the first clamp defines a first aperture therethrough, and wherein the first aperture is adapted to receive a first alignment pin connected to the first electrical connector.

16. The cable assembly of claim 15, wherein the second clamp defines a second aperture therethrough, and wherein the second aperture is adapted to receive a second alignment pin connected to the second electrical connector.

17. A method of assembling a cable assembly, the method comprising:
inserting a first end of a cable through a first opening of a first clamp; and
attaching the first end of the cable to a first electrical connector by mounting a first electrical contact of the first electrical connector to a first electrical lead of the cable.

18. The method of claim 17, wherein the first end of the cable is attached to the first connector after the first end of the cable is inserted through the first opening of the first clamp.

19. The method of claim 18, further comprising:
inserting a second end of a cable through a second opening of a second clamp; and
attaching the second end of the cable to a second electrical connector by mounting a second electrical contact of the second electrical connector to a second electrical lead of the cable.

20. The method of claim 19, wherein the second end of the cable is attached to the second connector after the second end of the cable is inserted through the second opening of the second clamp.
